(19) United States
(12) Patent Application Publication
(10) Pub. No.: US 2011/0007777 A1
(43) Pub. Date: Jan. 13, 2011

(54) LOW POWER RADIO SYSTEM

(75) Inventors: Jacobus Cornelius Haartsen, Hardenberg (NL); William O. Camp, JR., Chapel Hill, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 12/501,053

(22) Filed: Jul. 10, 2009

(51) Int. Cl. H04B 1/69

(52) U.S. Cl. 375/130; 375/E01.001

(57) ABSTRACT

A spread spectrum system may include a transmitter and a receiver. The transmitter is configured to transmit a signal having at least one channel, where the signal may include a reference signal, an information signal and a frequency offset between the reference signal and the information signal. The receiver may receive the transmitted signal from the transmitter and mix the received signal in order to retrieve the information signal from the received signal. This allows the receiver to operate at low power (e.g., 10 uW-100 uW).

### FIELD

The present invention relates to low power radio systems and methods.

### BACKGROUND

Currently, short-range radio communication systems (e.g. WLAN 802.11, Bluetooth, ZigBee, Z-Wave, etc.) use a bi-directional data exchange. These systems are based on connections that are controlled by higher-layer applications. Other short-range radio systems are based on unidirectional data transfer, where signals are only broadcasted and no connections are established.

For uni-directional systems, the emphasis should be on the receiver when it concerns power consumption. The transmitter is either activated very infrequently (e.g., a few times a day for a wake-up radio) or is connected to the main supply (e.g., for indoor positioning). As such, the receiver in these systems must operate almost continuously (“always on”) in order to provide short latencies. These systems also require high frequency oscillators which consume a high amount of power.

Current short-range radio receivers result in high power consumption, in the order of 10 mW to 100 mW. In addition, current short-range radio receivers provide uni-directional radio system designs that are influenced by radio interference and RF frequencies.

### SUMMARY OF THE INVENTION

In accordance with an embodiment of the present invention, a spread spectrum system may include a transmitter and a receiver. The transmitter is configured to transmit a signal having at least one channel, where the signal may include a reference signal, an information signal and a frequency offset between the reference signal and the information signal. The receiver may receive the transmitted signal from the transmitter and process the received transmitted signal in order to retrieve the information signal. This allows the receiver to operate at low power (e.g., 10 uW-100 uW).

In accordance with another embodiment of the present invention, a transmitter for use in a transmit reference spread spectrum system includes a signal source to generate a reference signal and at least one multiplier to generate a first channel. The first channel may include the reference signal multiplied with an information-bearing signal. The transmitter may further include an adder to add the first channel with the reference signal that is frequency-offsetted with regard to the first channel, resulting in a transmit signal. An antenna may be included to transmit the transmit signal.

In accordance with another embodiment of the present invention, a receiver for a transmit reference spread spectrum system may include an antenna to receive a transmitted signal and a mixing circuit. The transmitted signal may include a reference signal, at least one information-bearing signal and a frequency offset between the reference signal and the information signal. The mixing circuit determines the at least one information-bearing signal from the received transmitted signal.

Other aspects and features of the present invention, as defined solely by the claims, will become apparent to those ordinarily skilled in the art upon review of the following non-limiting detailed description of the invention in conjunction with the accompanying figures.

### BRIEF DESCRIPTION OF THE DRAWINGS

FIG. 1A is a system of exemplary devices having a transmit reference transmitter and other devices having a transmit reference receiver in accordance with one embodiment of the present invention;

FIG. 1B is a block diagram view of a transmit reference transmitter in accordance with one embodiment of the present invention;

FIG. 2A is a block diagram view of a transmit reference receiver in accordance with one embodiment of the present invention;

FIG. 2B is a block diagram view of a transmit reference receiver in accordance with another embodiment of the present invention;

FIG. 3 is a block diagram view of a transmit reference transmitter capable of transmitting a signal with multiple channels in accordance with an embodiment of the present invention;

FIG. 4 is a block diagram view of a transmit reference receiver capable of de-spreading a signal having multiple channels in accordance with an embodiment of the present invention; and

FIG. 5 is a block diagram view of a transmit reference receiver in accordance with another embodiment of the present invention.

### DETAILED DESCRIPTION OF EMBODIMENTS OF THE INVENTION

The following detailed description of embodiments refers to the accompanying drawings, which illustrate specific embodiments of the invention. Other embodiments having different structures and operations do not depart from the scope of the present invention.

Embodiments of the present invention may take the form of an entirely hardware embodiment that may be generally be referred to herein as a “module”, “device” or “system.”

Embodiments of the present invention are described below with reference to illustrations and/or flowchart of methods, apparatus (systems) and computer program products according to embodiments of the invention. It will be understood that each block of the flowchart illustrations and combinations of blocks in the flowchart illustrations, can be implemented by firmware, computer program instructions, or a combination thereof. Any computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As described in more depth herein, embodiments of the present invention relate to a Transmit Reference Spread Spectrum (TRSS) system which applies a frequency offset to separate the reference signal from the information signal. In contrast to conventional Direct Sequence Spread Spectrum (DSSS) systems where the spreading reference needs to be recreated in the receiver, in the TRSS system, the reference is embedded in the transmitted signal. Because the transmit signal contains the information and reference signals, acquisition and synchronization as required in DSSS systems are not necessary, and thus, the signal can be de-spread instantaneously irrespective of the processing gain. In conventional DSSS systems, a lengthy acquisition time is needed to synchronize the locally generated reference signal with the received signal, which also requires a larger processing gain. Moreover, in the TRSS system, the reference signal does not have to be extracted from the received signal, but de-spreading can be achieved directly by a mixing procedure as is later described. Finally, since the reference does not have to be recreated or extracted. As such, the reference can be anything, including wideband noise. In these respects it is quite different from a pilot signal which could be embedded in a DSSS system.

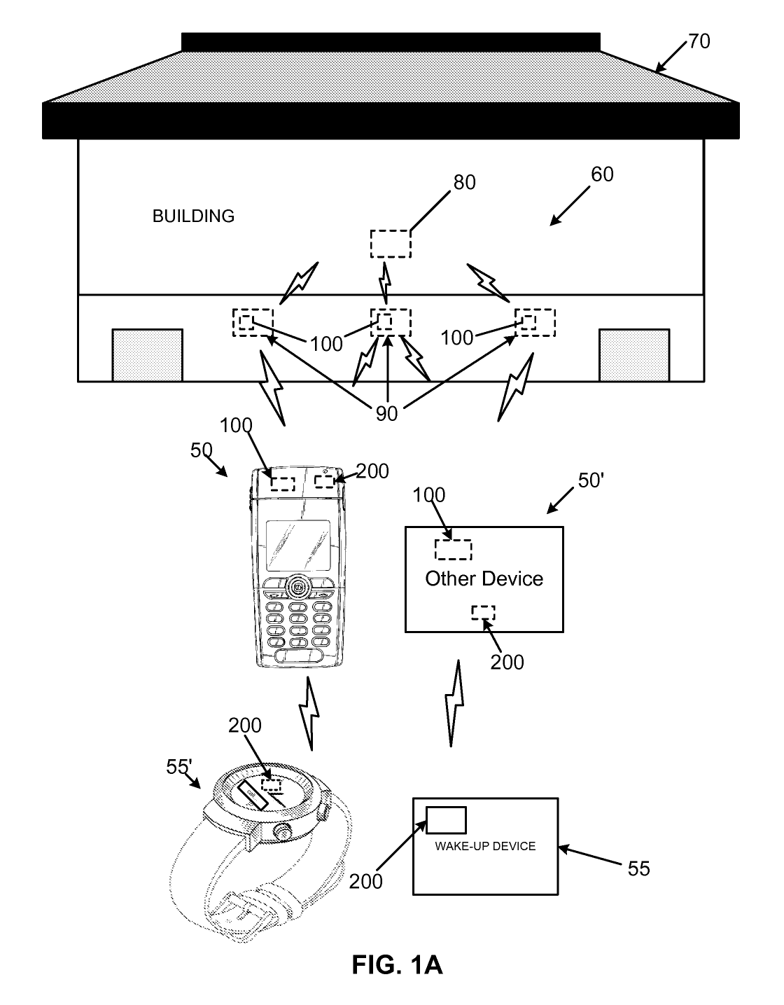

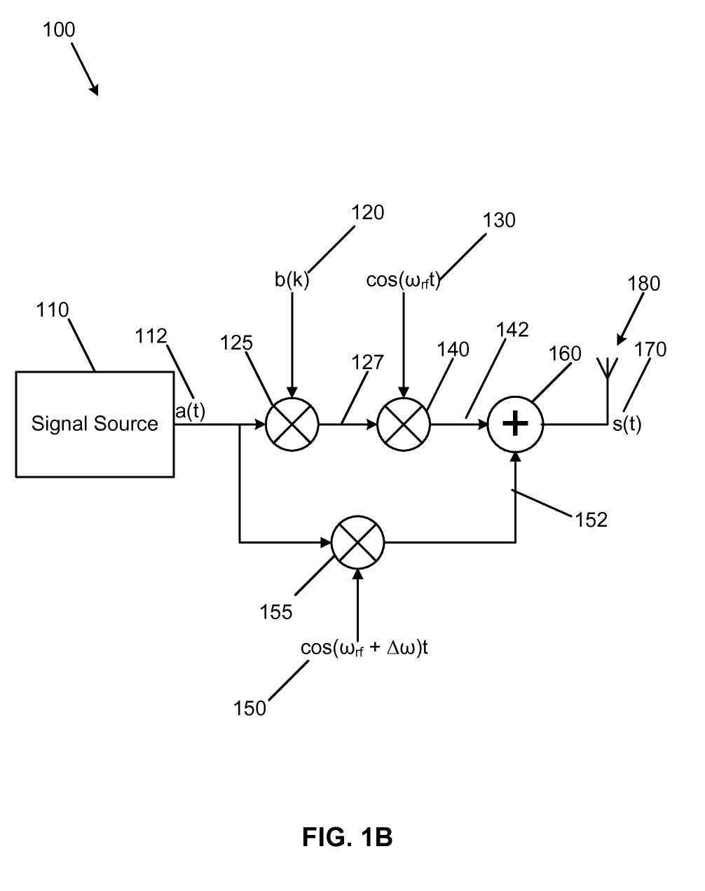

The following Figures illustrate exemplary embodiments of TRSS systems, TRSS transmitters and TRSS receivers. FIG. 1A is a system of exemplary devices having a transmit reference transmitter and other devices having a transmit reference receiver in accordance with one embodiment of the present invention. A TRSS transmitter and/or receiver, in some embodiments of the present invention, may be incorporated into any mobile device 50. Examples of such mobile devices 50 may include a cellular telephone 50, a watch 55′, a personal digital assistant (PDA), a cordless telephone, any portable computing device, a Bluetooth device, a laptop, any other electronic device 50′, and/or any other device. The phone 50 could include a TRSS receiver 200 so that it could be receiving TRSS signals from an indoor positioning system 60 or other system. Typically, very low power devices like the watch 55′ would only incorporate a TRSS receiver 200.

TRSS systems according to embodiments of the present invention may be used in uni-directional radio systems, including uni-directional short-range radio systems. One example of a uni-directional short-range radio system is a wake-up radio system 55. A wake-up radio system includes a wake-up receiver 200 and a transmitter 100 communicable together via a wireless message. At reception of this message by the wake-up receiver 200, which is transmitted by the transmitter 100, the wake-up receiver 200 will activate its host or other electronics associated with the wake-up receiver 200. For example, referring back to FIG. 1A, an exemplary wake-up receiver is illustrated as embedded in a watch 55′ or other wake up device 55. The cell phone 50 would be able to wake up the watch 55′ or other wake-up device 55 using its TRSS transmitter 100. For each device to be woken up, a specific wake-up message is used which has a bit sequence unique for the unit to be woken up. Specifically, the watch 55′ would receive a transmit signal (discussed later) sent from the transmitter 100 of the cell phone 50 when an incoming call or other alert occurs. Upon receipt of such transmit signal, the receiver 200 of the watch 55′ would activate (i.e., wake-up) at least a portion of the watch 55′ so that the watch 55′ could perform one or more actions, such as retrieve data from the transmit message, request data from the phone 50, display that a call is incoming, display that a message (e.g., email message, MMS message, SMS message, etc.) has arrived, alert the user that a reminder has occurred, or perform other activities associated with other triggering events. All of this would occur based on a low power radio system (e.g., low power wake-up system). Because the low-power feature of this system, the wake-up radio system 55 may be ideal for battery operated devices, such as a watch 55′ or other device.

Another example of a unidirectional short-range radio system is an indoor positioning estimation system 60 where one or more beacons 90 are spread out in a building 70 and broadcast positioning transmit messages to a recipient, which may be the cell phone 50, other mobile devices 50′, a controller 80, or any other type of processing device. The beacons 90 may include a transmitter 100 of the present invention. The recipient (e.g., cell phone 50′) receives the positioning messages via a receiver 200 of the present invention that may be embedded in the recipient. Based on these positioning messages, the recipient can determine the transmitter's location inside the building 70. For example, after receipt of the beacon signal, the recipient may retrieve information from the transmitted signal which indicates the beacon position (e.g., maps of the building, location of beacons, closest beacon position, etc.) or any other data desired to be transmitted to the recipient. In one embodiment, the beacon 90 may optionally, include a receiver of the present invention (not shown) so that the recipient can transmit a reply message to one or more beacons 90 upon recipient of the broadcast of the positioning messages or other messages from the beacons 90.

Other applications are also realized with the present invention and the wake-up system 55 and indoor positioning systems 60 are only meant to be two exemplary applications of the present invention.

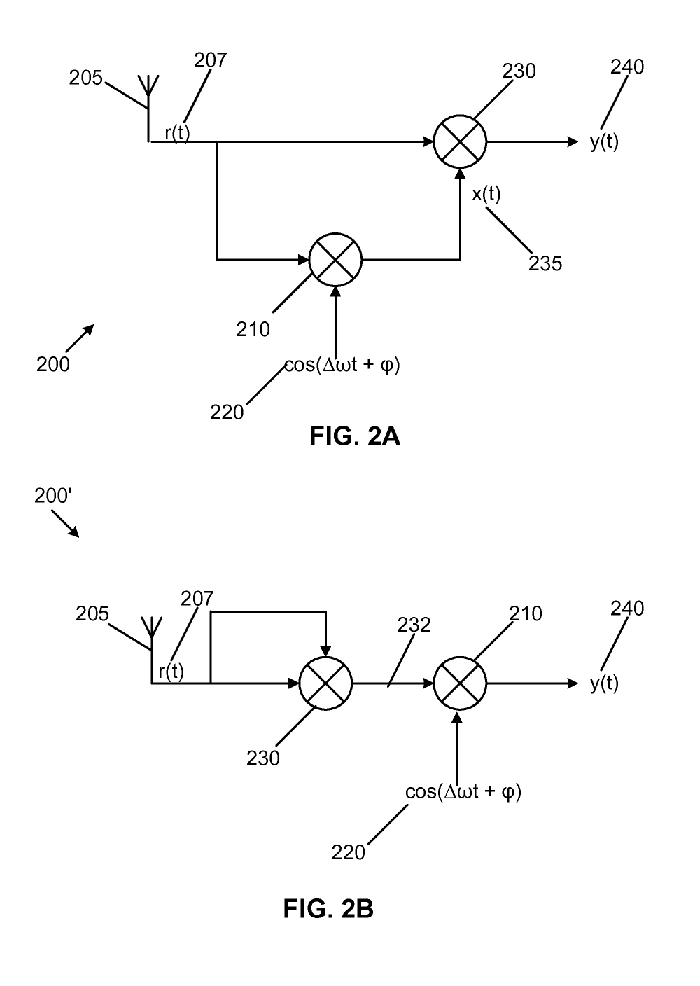

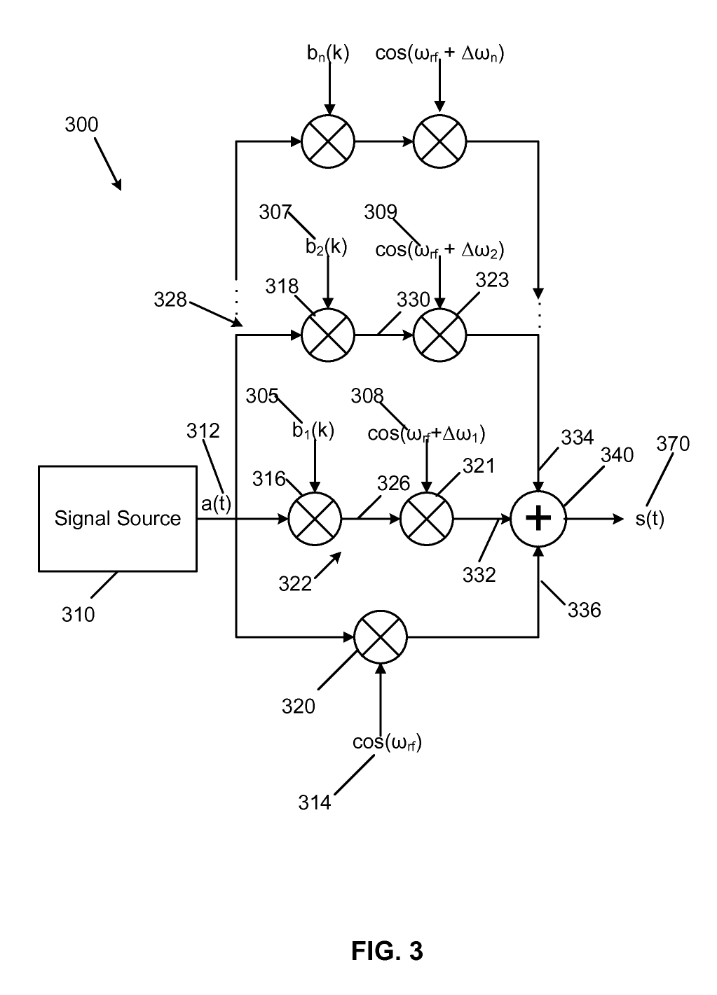

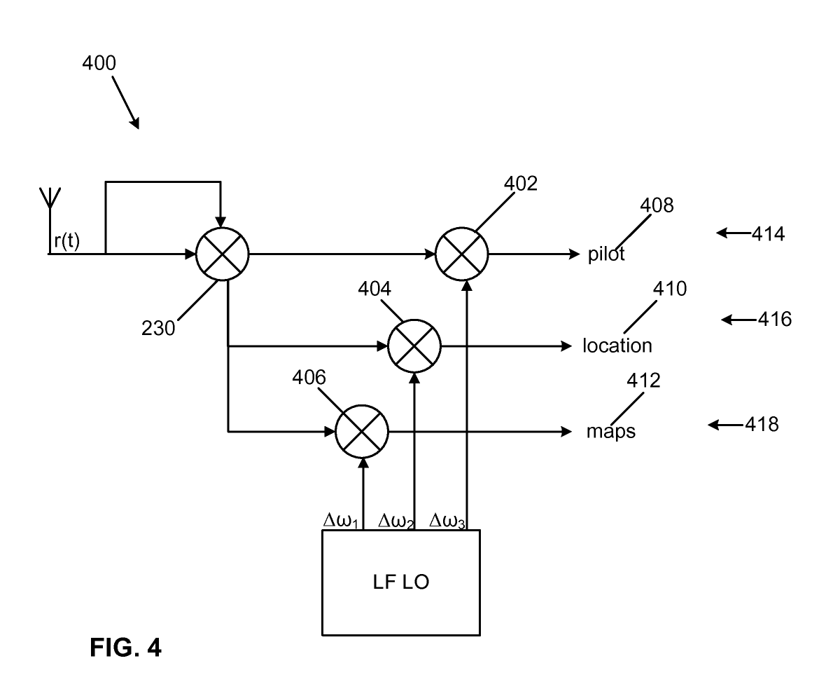

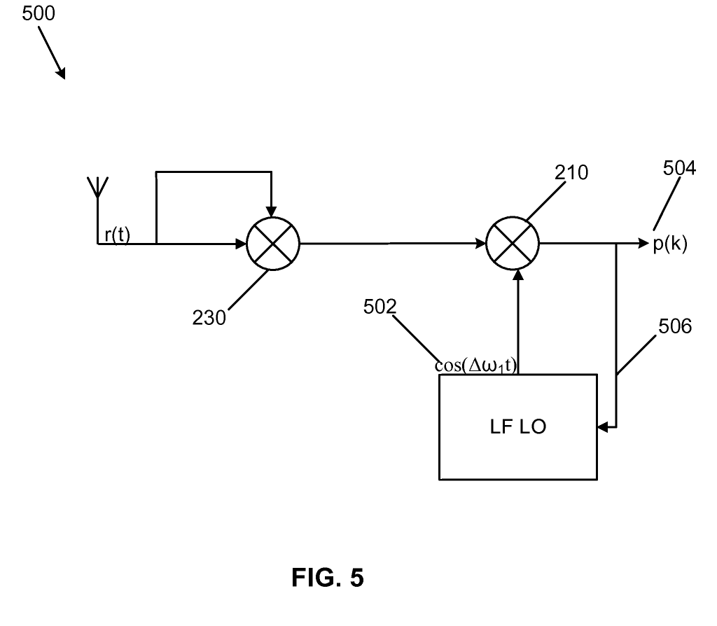

It should be noted that the transmitter and receivers presented in FIG. 1A may employ any transmitter or receiver in accordance with any embodiment of the present invention, including the embodiments 200, 300, 400, 500 illustrated in FIGS. 2-5 or any other embodiments of the present invention. For example, the transmitter presented in the mobile devices 55 and 55′ may be the transmitter 300 as illustrated in the exemplary embodiment of FIG. 3 and the receiver illustrated in FIG. 1A may be the receiver 400, 500 presented in the embodiments shown in FIGS. 4 or 5.

FIG. 1B is a block diagram view of a TRSS transmitter 100 in accordance with one exemplary embodiment of the present invention. The transmitter 100 includes a signal source 110 to generate a wideband reference signal, a(t), 112. The reference signal 112 may be any signal suitable for modulation by another signal. The reference signal 112 may be generated at any frequency, such as a specific radio frequency (RF), and can be generated using any electronics, such as a RF voltage controller oscillator (VCO) with reasonable accuracy. It should be understood that the reference signal 112 can be generated using any other electronics as the present invention is not limited to the reference signal generated by a RF VCO.

In one embodiment, the reference signal can be generated at baseband or intermediate frequency (IF) and then be up-converted to RF or other desired frequency. The bandwidth (e.g. RF band) of the reference signal 112 can be any desired bandwidth. In one embodiment, the reference signal 112 can be any RF band, such as any industrial, scientific and medical (ISM) band (e.g., 2.45 GHz). In another embodiment, the reference signal 112 can be any lower band, such as the FM band from 88 to 101 MHz. It should be understood that the reference signal 112 can be any band of frequencies and the present invention is not limited to only an RF band or FM band.

The reference signal 112 is modulated by the information-bearing data signal, b(k), 120, at multiplier 125, resulting in a first modulated signal 127. This data signal b(k) can use any modulation scheme, such as BPSK, QPSK, 16-QAM, etc. The modulated signal 127 is then multiplied with signal 130 (e.g., cos(ω_{rf}t)) by multiplier 140 where ω_{rf} is the RF carrier frequency. Additionally, a frequency offset signal 152 (e.g., a(t)*cos(ωrf+Δω)t) is created by multiplying signal 150 (e.g., cos(ω_{rf}+Δω)t) with reference signal a(t) 112 by multiplier 155, where Δω is the transmitted offset frequency. This resulting signal 152 is then is combined with a signal 142 (e.g., a(t)*b(k)*cos(ω_{rf}t)) by adder 160, resulting in a transmit signal s(t) 170. The transmit signal 170 is represented by:

s(t)=b(k)·a(t)·cos(ω_{rf}t)+a(t)·cos(ω_{rf}+Δω)t

where ω_{rf} is the RF carrier frequency and Δω is the offset frequency. Typically, the RF frequency ω_{rf} is in the order of 100 MHz to a few GHz, whereas the offset frequency Δω is in the order of a few kHz or MHz.

It is noted that the bandwidth BWₐ of the reference signal 112 is much broader than the bandwidth BW_{b} of the information-bearing data signal 120 so that a spectrum spreading results. In one exemplary embodiment, the reference bandwidth BWₐ is some tens of MHz. Since the offset frequency is much smaller (e.g., in the order of 1 MHz or less), the spectra of the reference signal 112 and combined data-reference signal almost completely overlap.

After the transmit signal s(t) 170 is generated, the transmit signal s(t) 170 may then be transmitted through an antenna 180 into surrounding space, which, in turn, may be received by a receiver 200, which is discussed below with regards to FIG. 2.

FIGS. 2A-2B illustrate block diagrams of exemplary transmit reference receivers 200, 200′ in accordance with some embodiments of the present invention. The receiver 200, 200′ includes an antenna 205, which receives the transmit signal s(t) 170 from the transmitter 100 after s(t) has traveled a certain distance.

Compared with the transmit signal s(t), the received signal r(t) at the receive antenna 205 will likely be attenuated because of the radio propagation. Furthermore, the transmit signal may be distorted due to multipath phenomena encountered on the radio propagation path. The received signal (or “received transmitted signal”), as referred to herein, relates to the propagated transmit signal, which may have been distorted.

In the receiver 200, 200′, the received signal (r(t)) 207 proceeds to at least two multipliers, 210 and 230, for de-spreading and, optionally, demodulation. The exact location and configuration of these multipliers can be variable. For example, FIG. 2A illustrates one configuration of the receiver 200: at multiplier 210, the received transmit signal r(t) 207 is multiplied by frequency offset signal 220 (e.g., cos(Δωt+φ) resulting in a frequency-shifted signal (x(t)) 235. This frequency-shifted signal x(t) 235 is represented by:

x(t)=r(t)·cos(Δωt+φ)=={b(k)a(t)·cos(ωᵣₜt)+a(t)·cos(ωᵣₜ+Δω)t}cos(Δωt+φ)

The frequency-shifted signal x(t) 235 is multiplied with the received transmit signal r(t) 207 by multiplier 230 resulting in the de-spread signal (y(t)) 240. It should be noted that de-spread signal 240 (y(t)=r(t)²cos(Δωt+φ) produced by the receiver 200 is a square of the received signal (r(t)²) multiplied by the frequency offset signal 220 (e.g., cos(Δωt+φ).

FIG. 2B illustrates an alternate embodiment where the position of the multipliers 210, 230 may be different than that presented in FIG. 2A, but still result in the same de-spread signal 240 ((y(t)=r(t)²cos(Δωt+φ). As illustrated, multiplier 230 may act as a squaring circuit first and then, the resulting signal 232 (r(t)²) is multiplied by signal 220 (e.g., cos(Δωt+φ) by multiplier 210. Again, this de-spread signal 240 (y(t)=r(t)²cos(Δωt+φ) is a square of the received signal (r(t)²) multiplied times the frequency offset signal 220 (e.g., cos(Δωt+φ). Thus, the demodulated signal 240 is the same whether the receiver of FIG. 2A or 2B is used.

It should be further noted that the RF frequency (ω_{rf}) does not occur in the receiver circuit, but instead, only the offset frequency (Δω). As such, there is no high-power RF local oscillator (LO) included or required in the receiver. Furthermore, the reference signal a(t) does not need to be regenerated in the receiver 200, 200′ for de-spreading or demodulation of the received signal 207.

Nonetheless, as previously mentioned, the receiver 200, 200′ squares the received signal r(t) 207. After squaring, the resulting signal 240 is calculated as follows:

y(t)=[b(k)·a(t)·cos(ω_{rf}t)+a(t)·cos(ω_{rf}+Δω)t]²=b²(k)a²(t)cos²(ω_{rf}t)+a²(t)cos²(ω_{rf}t+Δωt)+2b(k)a²(t){½ cos(Δωt)+½ cos(2ω_{rf}t+≢ωt)}=½b²(k)a²(t){1−cos(2ω_{rf}t)}+½a²(t){1−cos(2ω_{rf}t+2Δωt)}+b(k)a²(t){cos(Δωt)+cos(2ω_{rf}t+Δωt

As shown in the equation above, the resulting DC component at the carrier frequency is: ½{b²(k)·a²(t)+a²(t)} and the component at the offset frequency (Δω) is b(k)·a²(t). The components that are located at twice the RF carrier frequency (˜2ω_{rf}) may be ignored and thus, can be filtered away (or integrated and dumped) using a filter or like device.

To prevent inter-carrier interference, the spectrum of the squared reference a²(t) should resemble a Dirac impulse. To accomplish this, the reference signal 112 (a(t)) should produce a constant after squaring. This can be achieved by using a constant envelope function, e.g. a binary function. In one embodiment, if the reference signal 112 (a(t)) and the information-bearing signal 120 (b(k)) are binary signals (e.g., +1, −1), the resulting square will be a constant: a²=1, b²=1. In the frequency domain, the DC component (½{b²(k)·a²(t)+a²(t)}) of the demodulated data signal 240 is fixed, whereas the de-spread information-bearing signal 120 (b(k)) (i.e. after de-spreading in the receiver) arises at the offset frequency Δω. This information-bearing signal is thus extracted from the transmitted signal 170 without having to generate a reference signal or via the use of a high-frequency local oscillator. Nonetheless, since the squared reference signal at DC is a spike, there is no cross-interference between the information-bearing signal 120 and the reference signal 112. Subsequent mixing with the offset frequency Δω move the intermediate frequency (IF) portion of the signal to baseband where the information-bearing signal 120 (b(k)) can be retrieved.

If only squaring is applied, the desired de-spread information-bearing signal 120 will be located at the offset frequency Δω and this signal can be retrieved at IF. This may be advantageous since greater gains at IF can be obtained. In addition, the unknown or variable phase φ does not need to be retrieved.

In one embodiment, the symbol rate of the de-spread information-bearing signal 120 b(k) and the frequency offsets Δωᵢ are based on 32 kHz (or other low frequency) which is also used for the real-time clock. The receiver then only needs a low power oscillator (LPO) with a 32 kHz reference from which all clocks in the receiver are derived. The low frequency of the oscillator allows for a low power oscillator to be employed and thus, the receiver becomes a low powered device. In one embodiment, the power of the low power oscillator allows for the peak power consumption of the receiver to be fully operated at 10-100 μW. Thus, applications, such as wake-up radios, do not need to be based on amplitude shift keying (ASK) or on-off keying, and can still apply spectrum spreading to obtain robustness in a multi-path fading and interference-prone environment.

FIGS. 1B, 2A and 2B illustrate a TRSS system with a single channel carrying a single information-bearing signal 120 in the transmit signal 170. However, it should be understood that multiple information-bearing channels can be embedded in the transmit signal 170 by applying multiple data branches each with their own offset frequency Δωᵢ. FIG. 3 illustrates a block diagram view of an exemplary multiple channel transmit reference transmitter in accordance with an embodiment of the present invention.

It is noted that, in FIG. 3, the offset signals cos(ω_{rf}+Δω₁) 308 and cos(ω_{rf}+Δω₂) 309 are applied to the information-bearing signals 305 and 307 (bᵢ(k)) rather than to the reference signal 312 (a(t)). It should be understood that the offset signals cos(ω_{rf}+Δω₁) 308 and cos(ω_{rf}+Δω₂) 309 may be applied to either the respective data signals b₁(k) 305, b₂(k) 307 or the reference signal a(t) 312.

In determining the transmit signal s(t) 370 for the multiple channel transmitter 300, a signal source 310 first generates the reference signal 312.

The reference signal 312 is then sent to multiple different multipliers 320, 316 and 318. At multiplier 320, the reference signal 312 is multiplied by the carrier frequency signal (ω_{rf}) 314, resulting in a carrier reference signal 336. At a first channel branch 322, the reference signal 312 is multiplied by a first information-bearing signal (b₁(k)) 305 by a multiplier 316 and the resulting signal 326 is then multiplied by a first offset frequency signal (cos(ω_{rf}+Δω₁)) 308 by multiplier 321. At a second channel branch 328, the reference signal 312 is multiplied by a second information-bearing signal (b₂(k)) 307 by multiplier 318 and the resulting signal 330 is then multiplied by a second offset frequency signal (cos(ω_{rf}+Δω₂) 309 by multiplier 323. The modulation schemes for b₁(k) and b₂(k) may not necessarily be the same. For example, the modulation scheme for b₁(k) may be BPSK while the modulation schemes for b₂(k) may be QPSK. Nonetheless, the signals 332 and 334 resulting from each channel branch 322 and 328 are combined with the carrier reference signal 336 by adder 340 resulting in the transmit signal (s(t)) 370. The transmit signal (s(t)) 370 is thus:

s(t)=a(t)cos(ω_{rf}t)+b₁(k)·a(t)·cos(ω_{rf}+Δω₁)t+b₂(k)·a(t)·cos(ω_{rf}+Δω₂ )t

This transmit signal 370 is transmitted through an antenna of the transmitter 300 into space.

The optimal signal-to-noise ratio (SNR) is obtained when (Δωᵢ)=πn/T_{b} where T_{b} is the symbol period of the data signal b(k) and n an integer (e.g., n=1, 2 for 2 channels).

Because of the non-linear, squaring operation of the received signal r(t), self-interference will arise due to the inter-modulation mixing of different components of r(t). To avoid inter-modulation products to end up in viable channels, combinations of additions and/or subtractions of the offset frequencies should not be equal to any of the offset frequencies themselves (i.e., Δωᵢ±Δωⱼ≠Δωₖ where i, j, k=1, 2, 3, . . . n for n parallel channels). This can, for example, be realized by selecting odd harmonics (e.g., 1 MHz, 3 MHz, 5 MHz . . . 2m+1 MHz) for the offset frequencies for the channels. After squaring, the inter-modulation products due to self-interference will then end up at even harmonics (e.g., 0 MHz, 2 MHz, 4 MHz, 6 MHz, . . . 2m MHz) which are not on any of the viable channels. Other combinations are possible that equally prevent inter-modulation.

As an example, a TRSS system operating in the FM broadcast spectrum (88-101 MHz) could have a RF center frequency of ω_{rf}=98 MHz and a spreading bandwidth (BW) of 16 MHz. Assuming an information rate (R) of R=32 kb/s (based on the typical frequency of 32 kHz of a Real-Time clock), the offset frequencies could be chosen to be Δω₁=5 R=160 kHz, Δω₂=8 R=256 kHz, and Δω₃=11 R =352 kHz. Inter-modulation products due to self-interference as the square thereof will arrive at f=3 R=96 kHz, f=6 R=192 kHz, and f=10 R=320 kHz, each of which is adjacent to the desired signals. Furthermore, inter-modulation products caused by strong FM broadcast signals may arrive at f=200 kHz, f=300 kHz, f=400 kHz, and so on. The latter is based on the fact that the FM channel spacing is 100 kHz with at least a minimum separation of 200 kHz between adjacent FM channels. Also these inter-modulation products will be outside the bands of interest.

As another example, a TRSS system operating in the 2.4 GHz ISM spectrum could have a RF center frequency of ω_{rf}=2441 MHz and a spreading bandwidth of 80 MHz. Assuming the same information rate of R=32 kb/s, the same offset frequencies can be selected, as indicated in the above example. All radio standards operating in the 2.4 GHz ISM band have a channel grid and spacing of at least 1 MHz. The first inter-modulation product after squaring will be at 1 MHz which is well above the offset frequencies presented.

For a wake-up system or other systems, a single channel may suffice. The channel will send a specific bit sequence that will wake-up the receiver. Only if this specific bit sequence is received will the receiver wake-up its host. A pilot channel could be added to support the synchronization in the receiver. Note that this pilot will be generated at baseband and follows the same modulation and combination with offset carriers as the information-bearing signals. Preferably, the data stream bₚ(k) for the pilot uses a very simple modulation scheme like BPSK.

In one embodiment, the pilot channel is self-decoding. The pilot is obtained using the correct offset frequency between the reference and the pilot channel. As such, the pilot is obtained immediately and with minimal power. For example, to obtain the pilot, there is no need for a local oscillator at the RF frequency and the pilot does not need to be generated in the receiver.

In an indoor positioning system or other systems, multiple of channels could be added that provide different kinds of data. For example, we could have one pilot channel at Δω₁ which indicates that a beacon is present; a second channel at Δω₂ may carry positioning information; a third channel at Δω₃ may provide local maps that can be downloaded; and Δωₙ providing other information; and so on. A receiver for receiving multiple channels is shown in FIG. 4.

FIG. 4 is a block diagram view of a multiple channel transmit reference receiver 400 in accordance with an embodiment of the present invention. As illustrated in the exemplary embodiment, three mixers 402, 404, and 406 provide the signal for pilot data 408, location data 410, and map data 412, respectively, each of which are on different channels 414, 416, 418.

One exemplary embodiment, however, may only contain a single mixer that can be tuned to each of the different offset frequencies Δω₁, Δω₂ and Δω₃ For example, first, the receiver would tune to Δω₁ to look for a pilot signal. Once found, the pilot signal can give important information for fine synchronization and timing. Then, the receiver would tune to the second offset frequency Δω₂ to retrieve its position signal. Only in case the proper maps are not already in the host may the receiver tune to Δω₃ to download one or more maps. Although three channels 414, 416, 418 are illustrated in FIG. 4, any amount of channels may be employed in the transmitter 300 and receiver 400 as the present invention is not limited to any specific number of channels.

The pilot signal 408 may carry a simple one-zero sequence. This sequence should be easy to detect and can be a presence indication of an indoor beacon or a wake-up signal. The pilot 408 can also provide symbol and/or frame timing information to the receiver 400. Once found, this information can then be used by the receiver 400 to demodulate one or more channels 416, 418.

Further, the pilot signal 408 can be used to obtain the proper phase and frequency of the offset frequency Δω at the receiver 400. At the transmitter 300, an offset carrier of cos(Act) is applied. In the receiver 400, a signal cos((Δω+δ)t+φ) can be recreated and for proper demodulation, δ=0 and φ=0. We could obtain this by applying an IQ mixer (i.e., multiplying the signal with cos((Δω+δ)t+φ) and sin((Δω+δ)t+φ) and perform frequency and phase tracking in the digital domain to compensate for δ and φ.

FIG. 5 is a block diagram view of a transmit reference receiver 500 in accordance with yet another exemplary embodiment of the present invention. This receiver 500 is another lower power solution that embeds the cos(Δωt) information 502 in the pilot signal p(k) 504. To accomplish this, the one-zero pattern in the pilot 504 is phase and frequency synchronized to cos(Δωt) when created in the transmitter (not shown). The receiver 500 can lock to the pilot signal 504 (which may be AM modulated if δ≠0) to retrieve a sync signal 506 that can control the low power local oscillator (LF LO) at the receiver 500. The pilot channel of receiver 500 at offset frequency Δω₁ carries the one-zero pattern p(k) 504. This one-zero pattern is phase and frequency synchronized to cos(Δω₁) 502 in the transmitter. Since Δω₁, Δω₂, and Δω₃ are integer multiples of each other, the pilot 504 may also provide the sync signal 506 for the other channels. At the transmitter, the information-bearing signal and pilot channel 504 can be assigned different power levels. For the pilot signal 504, the SNR does not have to be very high since it only needs to lock a LF LO in a phase lock loop (PLL) configuration that creates the offset frequencies.

In addition to the phase and frequency synchronization, the pilot signal 504 can also provide a reference for the symbol timing and the frame timing on the other channels. The rising and falling edges of the zero-one pattern can be used for bit timing purposes. For frame timing, the one-zero sequences, whose length corresponds to the frame length, can be inverted and alternated. For example, for a frame length corresponding to 6 pilot symbols (note that a pilot symbol may be longer than the data symbols on the other channels; the pilot rate may be 32 kb/s whereas the data rate may be 320 kb/s) two sequences would be needed: 101010 and 010101. By alternating the sequences, we obtain a frame sync at the boundary of two sequence: 101010, 010101, 101010, etc. Alternatively, the frame sync may be embedded on the information-bearing channels itself, i.e. a specific bit pattern on the information-bearing channel may indicate the start of a frame.

The circuit results in a very low-current receiver that can operate below 1 mW levels. By properly dimensioning the system (selection of binary data and reference signals, off harmonic frequency offsets, all based on 32 kHz), a high-performance, robust system results. Self-synchronization is achieved by including a one-zero pattern as pilot channel.

The Figures illustrate the architecture, functionality, and operation of possible implementations of systems and methods according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by a human or special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A transmit reference spread spectrum system comprising:
a transmitter comprising:
a signal source to generate a reference signal; and
electronics configured to transmit a signal having at least one channel, wherein each channel comprises the reference signal, an information signal and a frequency offset between the reference signal and the information signal, wherein the reference signal has a constant envelope.

2. The transmit reference spread spectrum system of claim 1, wherein the offset frequency is configured to prevent inter-modulation.

3. The transmit spectrum system of claim 1, wherein the information signal comprises a pilot signal comprising a binary pattern, wherein the binary pattern is phase and frequency synchronized to the frequency offset, and wherein the receiver retrieves a sync signal from the pilot signal, the sync signal used in controlling an output of a low frequency local oscillator.

4. The transmit reference spread spectrum system of claim 1, wherein the at least one channel further comprises multiple channels, wherein each of the multiple channels comprises a mixing of the reference signal, a channel-specific information signal and a channel-specific frequency offset signal, wherein the multiple channels are added together along with the reference signal.

5. The transmit reference spread spectrum system of claim 1, wherein the transmitter comprises:
a first multiplier to multiply the reference signal with the information signal, resulting in a first mixed signal;
a second multiplier to multiply the first mixed signal with a first frequency signal, resulting in a second mixed signal;
a third multiplier to multiply the reference signal to a second frequency signal, resulting in a third mixed signal; and
an adder to add the third mixed signal with the second mixed signal to produce the transmitted signal such that the reference signal and information signal are each embedded in the transmitted signal,
wherein the first frequency signal is at a frequency that is different from the frequency of the second frequency signal.

6. The transmit reference spread spectrum system of claim 1, wherein the transmitter is employed in at least one of the following:
a uni-directional radio system;
a wake-up radio to activate or wake up a device attached to the receiver upon receipt of the transmitted signal; and
an indoor positioning system.

7. The transmit spectrum system of claim 1, wherein the transmitter is embedded in a mobile phone.

8. The transmit reference spread spectrum system of claim 1, further comprising a receiver configured to receive the transmit signal, wherein the transmit signal comprises a specific bit sequence that activates the receiver upon receipt.

9. The transmit reference spread spectrum system of claim 8, wherein the transmit signal further comprises a pilot channel to support synchronization in the receiver.

10. The transmit reference spread spectrum system of claim 9, wherein the pilot channel provides at least one of symbol timing information and frame timing information to the receiver to be used by the receiver to demodulate the at least one channel.

11. A transmit reference spread spectrum system comprising:
a receiver comprising:
an antenna to receive a signal, the received signal comprising at least one channel, where each channel comprises a reference signal, at least one information-bearing signal and a frequency offset between the reference signal and the information signal, wherein the reference signal has a constant envelope; and
a mixing circuit to retrieve the at least one information-bearing signal from the received signal.

12. The transmit reference spread spectrum system of claim 6, wherein the received signal comprises a specific bit sequence that will activate the receiver upon receipt of the transmit signal.

13. The transmit reference spread spectrum system of claim 6, wherein the at least one channel further comprises multiple channels, wherein each of the multiple channels comprises a multiplication of the reference signal, a channel-specific information signal and a channel-specific frequency offset signal.

14. The transmit reference spread spectrum system of claim 6, wherein the receiver retrieves a pilot from the received signal, the pilot providing at least one of symbol timing and frame timing information to the receiver.

15. The transmit reference spread spectrum system of claim 6, further comprising a transmitter configured to transmit the received signal with the reference signal embedded therein.

16. The transmit reference spread spectrum system of claim 1, wherein the receiver is employed in at least one of the following:
a uni-directional radio system;
a wake-up radio to activate or wake up a device attached to the receiver upon receipt of the transmitted signal; and
an indoor positioning system.

17. The transmit spectrum system of claim 16, wherein the receiver is embedded in one of a watch or a mobile phone.

18. A transmit reference spread spectrum system comprising:
a transmitter comprising:
a signal source generator to generate a reference signal;
electronics to generate a transmit signal, the transmit signal comprising multiple channels, wherein each channel comprises a multiplication of the reference signal, a channel-specific information signal and a channel-specific frequency offset signal, wherein the multiple channels are added together along with the reference signal, and wherein each of the multiple channels have an offset frequency (Δω) and each channel-specific offset frequency (Δω) is different from one another.

19. The transmit reference spread spectrum system of claim 18, wherein the electronics comprises:
a first multiplier to multiply the reference signal with the information signal, resulting in a first mixed signal;
a second multiplier to multiply the first mixed signal with a first frequency signal, resulting in a second mixed signal;
a third multiplier to multiply the reference signal to a second frequency signal, resulting in a third mixed signal; and
an adder to add the third mixed signal with the second mixed signal to produce the transmitted signal such that the reference signal and information signal are each embedded in the transmitted signal,
wherein the first frequency signal is at a frequency that is different from the frequency of the second frequency signal.

20. The transmit reference spread spectrum system of claim 18, wherein inter-modulation products are formed by one of an addition or subtraction of the offset frequencies (Δωᵢ±Δωⱼ) of at least two of the channels, and wherein the frequency (Δωᵢ±Δωⱼ) of each inter-modulation product is different from any of the channel-specific offset frequencies (Δω).

21. The transmit reference spread spectrum system of claim 20, wherein the offset frequencies (Δω) are at odd harmonics and the inter-modulation frequencies (Δωᵢ±Δωⱼ) are at even harmonics so as to avoid inter-modulation of the channels.

22. The transmit reference spread spectrum system of claim 18, further comprising a receiver comprising an antenna to receive the transmitted signal and electronics to self-decode the information signal from the transmitted signal.

23. A transmit reference spread spectrum system comprising:
a receiver comprising:
an antenna to receive a signal, the signal having multiple channels, where each channel comprises channel-specific information, a reference signal and a channel-specific offset frequency (Δω);
electronics to retrieve the channel-specific information from the received information from each channel using at least one mixer.

24. The transmit reference spread spectrum system of claim 23, wherein different independent channels are determined by the mixing circuit, the channels comprising at least a pilot signal, and wherein the pilot signal carries a continuous wave signal representing the frequency offset.

25. The transmit reference spread spectrum system of claim 23, wherein the at least one mixer comprises only a single mixer to tune into each of the channel-specific offset frequencies (Δω).

26. The transmit reference spread spectrum system of claim 25 wherein the single mixer independently tunes into each of a plurality of channels by tuning into each respective channel-specific offset frequency to retrieve an information signal located on each of the plurality of channels.

27. The transmit reference spread spectrum system of claim 25:
wherein the single mixer tunes into a first channel-specific offset frequency (Δω₁) to retrieve a pilot signal, wherein the pilot signal comprises information associated with synchronization and timing,
wherein the single mixer tunes into a second channel-specific offset frequency (Δω₂) to retrieve information from a second channel, to retrieve a positioning signal, and
wherein the single mixer tunes into a third channel-specific offset frequency (Δω₃) to retrieve information from a third channel, to retrieve one or more maps.

28. The transmit reference spread spectrum system of claim 23, wherein the at least one mixer comprises a plurality of mixers, each of the plurality of mixers being tuned to each respective channel-specific offset frequency (Δω) in retrieving information from each respective channel.

29. The transmit reference spread spectrum system of claim 23, wherein the multiple channels comprise at least a pilot signal used to obtain a phase and frequency of the channel-specific offset frequency (Δω).

30. The transmit reference spread spectrum system of claim 23, wherein the multiple channels comprise a first channel comprising at least a pilot signal, where the pilot signal provides a reference for symbol timing and frame timing on the other channels.
